(19) United States
(12) Patent Application Publication
(10) Pub. No.: US 2026/0175239 A1
(43) Pub. Date: Jun. 25, 2026

(54) HOT MELT ADHESIVE FOAM DISPENSING SYSTEM IMPLEMENTING A HEAT EXCHANGER AND PROCESS IMPLEMENTING A HOT MELT ADHESIVE FOAM DISPENSING SYSTEM

(71) Applicant: Nordson Corporation, Westlake, OH (US)

(72) Inventors: Laurence B. SAIDMAN, Duluth, GA (US); Chuck GANZER, Westlake, OH (US); Steve CLARK, Westlake, OH (US)

(73) Assignee: Nordson Corporation, Westlake, OH (US)

(21) Appl. No.: 19/128,261

(22) PCT Filed: Nov. 3, 2023
(86) PCT No.: PCT/US2023/078586

§ 371 Date: May 8, 2025

Related U.S. Application Data
(60) Provisional application No. 63/427,248, filed on Nov. 22, 2022.

(51) Int. Cl. B05B 7/00; B05B 7/16; B05B 15/58

(52) U.S. Cl. CPC B05B 7/0018; B05B 7/168; B05B 15/58

(57) ABSTRACT

A dispensing system includes an impeller device configured to receive a hot melt adhesive; a pump having a first input configured to receive the hot melt adhesive and a second input configured to receive a gas, where the pump is configured to mix the hot melt adhesive and the gas to produce a solution and pump the solution at a volumetric flow rate; a valve configured to control an amount of the gas provided to the pump through the second input; and a dispenser configured to receive the solution from the pump and dispense the solution to create the hot melt adhesive foam.

### CROSS-REFERENCE TO RELATED APPLICATIONS

This application is a National Stage Application of International Patent App. No. PCT/US2023/078586, filed Nov. 3, 2023, which claims the benefit of U.S. Provisional Patent App. No. 63/427,248, filed Nov. 22, 2022, the entire disclosures of both of which are hereby incorporated by reference as if set forth in their entirety herein.

### TECHNICAL FIELD

This disclosure generally relates to hot melt adhesive foam dispensing systems. This disclosure further generally relates to hot melt adhesive foam dispensing systems implementing a heat exchanger. Further, the disclosure generally relates to processes for implementing hot melt adhesive foam dispensing systems. This disclosure further generally relates to processes for implementing hot melt adhesive foam dispensing systems implementing a heat exchanger.

### BACKGROUND

Hot melt thermoplastic adhesives are used in a number of applications such as packaging and product assembly. In conventional hot melt adhesive foam dispensing systems, a pump supplies an adhesive and gas solution to an adhesive dispenser, which can be referred to as a gun. The gun contains a valve at an outlet nozzle through which the solution is dispensed to atmospheric pressure. When the solution is dispensed, the gas is released from the solution to become entrapped in the adhesive to form a foam on a substrate to which the adhesive is applied. During operation of conventional hot melt adhesive foam dispensing systems, it is desirable to maintain a consistent quality of hot melt adhesive foam applied to the substrate, such that the substrate with the applied foam meets particular product specifications.

In this regard, there is a desire to increase output of the current systems. However, attempts at increasing system output have resulted in poor performance. Further, current systems utilize a density controller that is implemented as an electromechanical on-off control system. In this regard, the electromechanical on-off control system utilizes a slug and a spring. The slug is typically in communication with a pressurized portion of the system and the pressurized portion of the system presses against the slug and compresses the spring. In this regard, as gas content increases, the pump efficiency decreases and the flow decreases as well. This reduces the slug force as well as reduces spring compression. In response, gas is injected when the spring is compressed enough for the slug to make electrical contact with the manually adjustable contact. Gas is turned off when electrical contact is broken due to decreased slug force.

Moreover, current systems also utilize a density controller (DC). In this regard, a user must select the proper slug, such as a one hole slug, a two hole slug, a four hole slug, and/or the like based on viscosity of the material. In this regard, the density controller is sensitive to flow rate and viscosity. Moreover, changes to pump speed and/or temperature affects density control setting. Accordingly, interdependence of pump speed and temperature can make it difficult for the user to set controls to desired operating point. Moreover, the density controller is typically difficult and costly to automate adjustment. For example, motorization control, position control, and/or the like. Further, current systems also utilize a pressure control valve (PCV). In this regard, the pressure control valve (PCV) does not control pressure well especially with gas present. Moreover, the pressure control valve (PCV) has a tendency to drift, stick, and/or the like.

Accordingly, what is needed is a hot melt adhesive foam dispensing system having improved performance. In aspects, what is needed is a hot melt adhesive foam dispensing system having improved performance that addresses the deficiencies described above.

### SUMMARY

In one general aspect, a dispensing system includes an impeller device configured to receive a hot melt adhesive; a pump having a first input configured to receive the hot melt adhesive and a second input configured to receive a gas, where the pump is configured to mix the hot melt adhesive and the gas to produce a solution and pump the solution at a volumetric flow rate; a valve configured to control an amount of the gas provided to the pump through the second input; and a dispenser configured to receive the solution from the pump and dispense the solution to create the hot melt adhesive foam.

In one general aspect, a method includes receiving a hot melt adhesive to an impeller device from a hot melt adhesive source. The method in addition includes receiving a gas from a gas source. The method moreover includes mixing the hot melt adhesive and the gas to produce a solution. The method also includes pumping the solution from a pump to a dispenser at a volumetric flow rate. The method in addition includes dispensing the solution to create the hot melt adhesive foam.

In one general aspect, a dispensing system includes a heat exchanger arranged in a manifold and/or includes a manifold. The dispensing system in addition includes a pump having a first input configured to receive a hot melt adhesive and a second input configured to receive a gas, where the pump is configured to mix the hot melt adhesive and the gas to produce a solution and pump the solution at a volumetric flow rate; a valve configured to control an amount of the gas provided to the pump through the second input; and a dispenser configured to receive the solution from the pump and dispense the solution to create the hot melt adhesive foam.

In one general aspect, a method includes receiving a hot melt adhesive to an impeller device from a hot melt adhesive source. The method in addition includes receiving a gas from a gas source. The method moreover includes mixing the hot melt adhesive and the gas to produce a solution. The method also includes pumping the solution from a pump to a dispenser at a volumetric flow rate; lowering a temperature of the hot melt adhesive with a heat exchanger arranged in a manifold and/or includes a manifold; and dispensing the solution to create the hot melt adhesive foam.

### BRIEF DESCRIPTION OF THE DRAWINGS

The foregoing summary, as well as the following detailed description, will be better understood when read in conjunction with the appended drawings. The drawings show illustrative aspects of the disclosure. It should be understood, however, that the application is not limited to the precise arrangements and instrumentalities shown.

FIG. 1 illustrates a schematic diagram of a dispensing system according to an aspect of the disclosure.

FIG. 2 illustrates a perspective view of an exemplary implementation of the dispensing system according to aspects of the disclosure.

FIG. 3 illustrates a front view of an exemplary implementation of the dispensing system according to FIG. 2.

FIG. 4, which includes FIG. 4A, FIG. 4B, and FIG. 4C, illustrates a top view of an exemplary implementation of the impeller according to aspects of the disclosure.

FIG. 5, which includes FIG. 5A, FIG. 5B, FIG. 5C, FIG. 5D, and FIG. 5E illustrates a front perspective view of an exemplary implementation of the impeller according to FIG. 4.

FIG. 6 illustrates a perspective view of an exemplary implementation of the dispensing system with details of the heat exchanger according to aspects of the disclosure.

FIG. 7 illustrates an internal perspective view of an exemplary implementation of the dispensing system with details of the heat exchanger according to FIG. 6.

FIG. 8 illustrates a cross-sectional view of an exemplary implementation of the heat exchanger according to aspects of the disclosure.

FIG. 9 illustrates a temperature of the solution in the heat exchanger implemented according to the disclosure.

FIG. 10 illustrates a perspective view of an exemplary implementation of the dispensing system with details of the temperature sensor according to aspects of the disclosure.

FIG. 11 illustrates a front view of an exemplary implementation of the dispensing system with details of the temperature sensor according to FIG. 10.

FIG. 12 illustrates a cross-sectional view of an exemplary implementation of the dispenser valve according to aspects of the disclosure.

FIG. 13 illustrates a cross-sectional view of an exemplary implementation of the first stage according to aspects of the disclosure.

FIG. 14 illustrates a cross-sectional view of an exemplary implementation of the second stage according to aspects of the disclosure.

### DETAILED DESCRIPTION OF ILLUSTRATIVE ASPECTS

Aspects of the disclosed dispensing system are configured to implement satisfactory scaling up of a size of a pump. In this regard, during initial attempts at scaling up of a size of the pump, it was found that the dispensing system demonstrated poor performance. After further investigation, it was determined that the problems associated with scaling of a size of the pump was not due to inadequate mixing, but rather overheating adhesive. In particular, in an exemplary implementation of a current dispensing system, a heat rise of up to 50 degrees F. was observed. This heat rise would easily cause outlet hoses of the dispensing system, as well as other components, to go into an overtemperature condition.

Accordingly, the disclosed implementation of the dispensing system implements a heat exchanger as disclosed to reduce the temperature of the adhesive to result in a higher maximum workable RPM of the pump and output rate of the dispensing system. The various implementations of the heat exchanger have been shown in simulation to operate such that the adhesive can reliably be cooled at least 20 degrees F. at exemplary flowrates of adhesive through the dispensing system.

Further, current implementations were found to dramatically result in pump efficiency dropping as it was operated to compress the gas in a current recirculation stream. In a typical 50% density reduction scenario, the pump may be acting as a gas compressor just as much as a typical hot melt volumetric pump (40-45% efficiency). In this regard, compressing gas generated a great deal of heat. The disclosed heat exchanger addresses this generation of heat.

Further, initial implementations of a heat exchanger utilizing a multiple parallel tube heat exchanger were found largely ineffective at the high flow rates expected for implementation of the dispensing system of the disclosure. In laminar flow, which is typical for hot melt systems, the radius of the tube can be considered to cancel out of a heat transfer equation and only a length and a number of parallel tubes matter. It was found that even an implementation of a heat exchanger utilizing ten parallel tubes across a full length of a manifold would drop the temperature less than 5° F.

In this regard, the disclosure implements a heat exchanger with, for example, two parallel 1.5 inch diameter bores with inserts that create a 0.060 inch to 0.080 inch fluid layer that result in acceptable pressure drop and are able to drop the adhesive temperature from 375° F. into the 360-365 degree F. range.

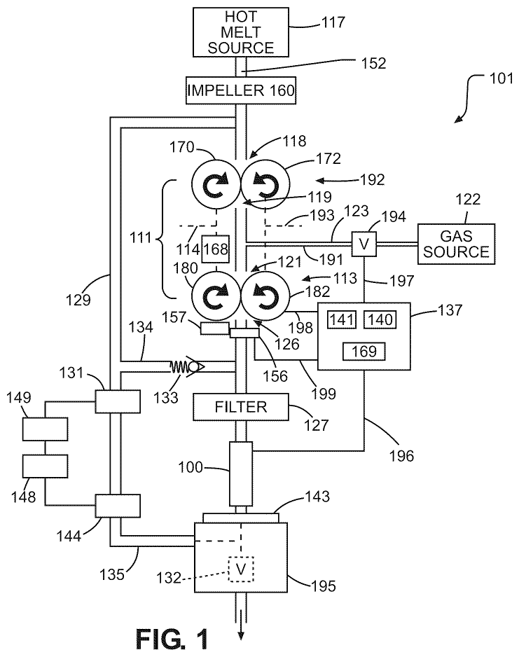

FIG. 1 illustrates a schematic diagram of a dispensing system according to an aspect of the disclosure.

With initial reference to FIG. 1, a dispensing system 101 for dispensing hot melt adhesive foam onto a substrate in accordance with an aspect of the disclosure can include an impeller device 160, a pump 111, and/or the like.

The impeller device 160 can include a first input 152 configured to receive a hot melt adhesive. Specifically, the hot melt adhesive can be provided to the impeller device 160 through the first input 152 from a hot melt adhesive source 117. The hot melt adhesive source 117 can be a conventional adhesive melter configured to store solid adhesive, melt the solid adhesive into hot melt adhesive, selectively provide the impeller device 160 with the hot melt adhesive, and/or the like. However, the hot melt adhesive source 117 can be any conventional type of hot melt adhesive source as desired. Further, the impeller device 160 may output the hot melt adhesive to the pump 111.

In aspects, the impeller device 160 may be configured in the dispensing system 101 to improve efficiency of the dispensing system 101, generate a higher output rate of the dispensing system 101, and/or the like. Further, aspects of the impeller device 160 are configured for improve operation of the dispensing system 101 including capturing gas from a recirculation system of the dispensing system 101. In this regard, if the dispensing system 101 is over gassed, implementation of the dispensing system 101 without the impeller device 160 may take longer to recover without dispensing adhesive.

In aspects, the impeller device 160 may be configured and/or implemented as a semi open impeller driven by common idler shaft 193. In aspects, the impeller device 160 may be configured and/or implemented to generate positive pressure to an inlet port of the pump 111 under generally all operating conditions of the dispensing system 101. The impeller device 160 may be located between the adhesive source 117 and the second recirculation channel 129. As such, the impeller device 160 may be configured to keep the gas in recirculation under some pressure, minimizing the compression and increasing the efficiency of the pump 111 for the same gas content. In aspects, the pump 111 may be configured to keep this stream above atmospheric pressure.

The impeller device 160 may be implemented as a pump inlet priming impeller. In aspects, the impeller device 160 increases mix energy within the dispensing system 101 thereby improving foam quality at low to mid-range pump speeds of the pump 111. Further, the impeller device 160 is configured to reduce heat rise due to increased pump efficiency with better mixed gas. Moreover, the impeller device 160 may be configured to reduce frothing in a tank that may be associated with the adhesive source 117.

The pump 111 can be a gear pump, such as (without limitation) a two-stage pump having a first stage 192 and a second stage 113, or any other suitable pump. In aspects, the pump 111 may be implemented with double stacked gear sets.

In aspects, the first stage 192 can include an oppositely rotating and meshed gear pair and the second stage 113 can include oppositely rotating and meshed gear pair. For example, the first stage 192 of the pump 111 can include a first gear 170 and a second gear 172. In this regard, the first gear 170 and the second gear 172 may rotate oppositely and may be meshed with one another. Similarly, the second stage 113 of the pump 111 can include a first gear 180 and a second gear 182. In this regard, the first gear 180 and the second gear 182 may rotate oppositely and may be meshed with one another. In one aspect, the first gear 170 of the first stage 192 and the first gear 180 of the second stage 113 may define driven gears that are connected by a common drive shaft 114. Accordingly, the first gear 170 of the first stage 192 and the first gear 180 of the second stage 113 may rotate in the same direction as they may be connected by the common drive shaft 114. In this aspect, the second gear 172 of the first stage 192 and the second gear 182 of the second stage 113 may define idler gears that are connected by the common idler shaft 193. Accordingly, the second gear 172 of the first stage 192 and the second gear 182 of the second stage 113 may rotate in the same direction as they may be connected by the common idler shaft 193.

The common drive shaft 114 may be driven by a motor 168. The motor 168 may include a motor controller 169. The motor controller 169 may control an RPM of the pump 111 and/or an RPM the motor 168.

Once the hot melt adhesive is received by the pump 111 from the impeller device 160, the hot melt adhesive can be fed into an inlet 118 of the first stage 192 of the pump 111. The first stage 192 can also include an outlet 119, such that the first stage 192 can deliver the hot melt adhesive to the outlet 119 at a metered rate.

After exiting the outlet 119 of the first stage 192, the hot melt adhesive can be introduced into an inlet 121 of the second stage 113 of the pump 111 flowing at the metered rate. In addition to the hot melt adhesive, gas can be provided from a gas source 122 into a second input 191 of the pump 111.

Specifically, the gas can flow from the gas source 122, through a gas line 123, through the second input 191, and into the inlet 121 of the second stage 113. The gas may be, for example, nitrogen, air, carbon dioxide, and/or the like, though other gasses are contemplated.

The dispensing system 101 can also include a gas valve 194 in fluid communication with the gas line 123 between the gas source 122 and the second input 191. The gas valve 194 can be configured to control an amount of gas provided to the pump 111 through the second input 191.

After being received through the inlet 121 of the second stage 113, the gas from the gas source 122 and the hot melt adhesive from the outlet 119 of the first stage 192 are mixed in the second stage 113 of the pump 111. The pump 111 may be configured to mix the hot melt adhesive and the gas under such pressure that the gas goes into solution with the molten adhesive. The pump 111 can then pump the solution at a volumetric flow rate from an outlet 126 of the second stage 113 of the pump 111.

After exiting the outlet 126, a temperature sensor 156 in fluid communication with the solution can be configured to detect a temperature of the solution. In the depicted aspect, the temperature sensor 156 can be positioned adjacent the outlet 126 of the second stage 113, though other positions are contemplated.

Additionally, a heat exchanger 157 can be positioned adjacent the outlet 126, where the heat exchanger 157 can be configured to selectively decrease the temperature of the solution exiting the outlet 126. The solution can then flow through a filter 127 to a gear flow meter 100. As such, the filter 127 can be fluidly disposed between the pump 111 and the gear flow meter 100. In other aspects, the dispensing system 101 may be implemented without the gear flow meter 100. In this aspect, the solution can then flow through a filter 127 to the dispenser 195 directly and/or through intervening components. The filter 127 can be configured to separate any hardened particles of the hot melt adhesive that may have solidified while passing through the pump 111 or were never melted by the hot melt adhesive source 117.

The gear flow meter 100 can be configured to measure the volumetric flow rate of the solution pumped by the pump 111. Thus, the gear flow meter 100 can be implemented as a volumetric flow meter. In some examples, the gear flow meter 100 can be implemented as a gear flow meter. However, it will be understood that other suitable flow meters may be employed.

After flowing through the gear flow meter 100, the solution can be provided to a dispenser 195, which can comprise a valved adhesive dispensing gun and/or the like. The dispenser 195 can be configured to receive the solution from the gear flow meter 100 and dispense the solution onto a substrate so as to create a hot melt adhesive foam, as the gas previously comprising the solution will be released from the solution and become entrapped in the adhesive.

During normal operation of the dispensing system 101, the solution that flows from the outlet 126 of the second stage 113 of the pump 111 is fluidly coupled to the inlet 118. For example, the dispensing system 101 can include a first recirculation channel 135 and a second recirculation channel 129 configured to selectively direct the solution from the dispenser 195 to the pump 111.

The dispenser 195 can include a dispenser valve 132 that may be configured to be transitioned between an open position, in which the dispenser 195 dispenses at least a portion of the solution, and a closed position, in which the dispenser 195 dispenses none of the solution.

When the dispenser valve 132 is in an open position, and thus the dispenser 195 is dispensing the solution, a portion, such as for example 75%, of the solution is recirculated through the first recirculation channel 135 and the second recirculation channel 129. Likewise, the remaining 25% of the flow of solution from the pump 111 can be dispensed by the dispenser 195. Though one particular split of the solution is described, this is exemplary only and the solution can be split in different percentages as desired. For example, any percentage from 1% to 100% of the solution can be dispensed from the dispenser 195 when the dispenser valve 132 is in the open position. When the dispenser valve 132 is closed, all of the solution flowing from the outlet 126 of the second stage 113 of the pump 111 can be recirculated through the second recirculation channel 129.

The dispensing system 101 can include a translucent panel 143 connected to the dispenser 195. The translucent panel 143 can include a window that allows an operator of the dispensing system 101 to view the solution. In particular, the translucent panel 143 may allow a user to view gas bubbles within the solution as the solution flows into the first recirculation channel 135.

As objectively measuring quality of the hot melt adhesive foam applied to the substrate can be difficult using various measuring devices, the translucent panel 143 allows the operator to easily monitor solution quality and make adjustments to the operation of the dispensing system 101 accordingly. The operator can also monitor the quality of the hot melt adhesive foam being dispensed from the dispenser 195 and make adjustments to the operation of the dispensing system 101 accordingly.

As the amount of solution flowing through the first recirculation channel 135 and the second recirculation channel 129 can vary as described above during operation of the dispensing system 101, the pressure of the solution within the dispenser 195 can be affected by the pressure of the material flowing through the first recirculation channel 135 and the second recirculation channel 129. As such, the dispensing system 101 can contain devices for controlling the pressure of the solution flowing through the first recirculation channel 135 and the second recirculation channel 129.

In one aspect, the dispensing system 101 can include a pressure regulator 131 in fluid communication with the first recirculation channel 135 and the second recirculation channel 129, where the pressure regulator 131 is configured to control the pressure of solution flowing through the first recirculation channel 135. Though the pressure regulator 131 is depicted as connected to the first recirculation channel 135, in other aspects the pressure regulator 131 can be connected to the second recirculation channel 129. The pressure regulator 131 can be controlled by a transducer 149, such as an electro-pneumatic (E/P) transducer that is configured to selectively actuate the pressure regulator 131. However, any conventional device for controlling operation of a pressure regulator 131 can alternatively be utilized.

The dispensing system 101 can also include a pressure sensor 144 in fluid communication with the first recirculation channel 135, where the pressure sensor 144 is configured to measure the pressure of the solution flowing through the first recirculation channel 135 upstream from the pressure regulator 131. The pressure sensor 144 can be a pressure transducer, though other conventional pressure-measuring devices can be utilized. Both the transducer 149 and the pressure sensor 144 can be in signal communication with a controller 148, where the controller 148 is configured to receive signals from the pressure sensor 144 that are indicative of the pressure of the solution flowing through the first recirculation channel 135. The controller 148 can utilize this signal to control the transducer 149, and thus the pressure regulator 131, so as to instruct the transducer 149 to actuate the pressure regulator 131 based on the pressure measured by the pressure sensors 144. As a result, the dispensing system 101 can maintain a substantially consistent pressure of the solution at the dispenser 195.

In one aspect, the controller 148 may be a PID controller. However, the controller 148 can alternatively be a proportional controller, or any other type of controller capable of controlling the transducer 149 based upon signals received from the pressure sensor 144. Further, the controller 148 can be configured to receive a user input from an operator of the dispensing system 101 so as to set the desired pressure of the solution flowing through the first recirculation channel 135.

In aspects, the PID controller implementation of the controller 148 may implement a control loop mechanism employing feedback, such as pressure measured by the pressure sensors 144. In this regard, the PID controller implementation of the controller 148 may continuously calculate an error value as a difference between a desired setpoint and a measured process variable, such as pressure measured by the pressure sensors 144, and apply a correction based on a proportional term, an integral term, and a derivative term. In another aspect, the controller 148 can comprise a proportional controller. However, it is contemplated that the controller 148 can comprise any suitable computing device configured to host a software application for monitoring and controlling various operations of the dispensing system 101 as described herein.

During operation of the dispensing system 101, the solution can become blocked within various components of the system. For example, the solution can become blocked as the solution flows through the outlet 126 of the second stage 113 of the pump 111, such as in the filter 127 or the dispenser 195. Such blockages can result in a pressure buildup at the outlet 126, thus negatively affecting operation of the dispensing system 101. To prevent this, the dispensing system 101 can include a pressure relief path 134 that is in communication with the outlet 126 of the second stage 113 of the pump 111 and extends to the second recirculation channel 129. A pressure relief valve 133 can be connected to the pressure relief path 134 and can be configured to open upon the pressure of fluid flowing from the outlet 126 reaching a predetermined threshold. When the pressure of the solution reaches the predetermined threshold, opening of the pressure relief valve 133 allows the solution to escape to the second recirculation channel 129 and flow to the inlet 118 of the pump 111. Accordingly, the pressure relief valve 133 and pressure relief path 134 can prevent excessively pressurized solution from building up at the outlet 126 of the second stage 113 of the pump 111.

To control the various components of the dispensing system 101, the dispensing system 101 can include a controller 137. In one aspect, the controller 137 can comprise a proportional-integral-derivative controller (PID controller or three-term controller). In aspects, the PID controller implementation of the controller 137 may implement a control loop mechanism employing feedback. In this regard, the PID controller implementation of the controller 137 may continuously calculate an error value as a difference between a desired setpoint and a measured process variable and apply a correction based on a proportional term, an integral term, and a derivative term. In another aspect, the controller 137 can comprise a proportional controller. However, it is contemplated that the controller 137 can comprise any suitable computing device configured to host a software application for monitoring and controlling various operations of the dispensing system 101 as described herein.

It will be understood that the controller 137 can include any appropriate computing device, examples of which include a processor, a desktop computing device, a server computing device, or a portable computing device, such as a laptop, tablet, or smart phone. Specifically, the controller 137 can include a memory 140 and a human-machine interface (HMI) or HMI device 141. The memory 140 can be volatile (such as some types of RAM), non-volatile (such as ROM, flash memory, etc.), or a combination thereof. The controller 137 can include additional storage (e.g., removable storage and/or non-removable storage) including, but not limited to, tape, flash memory, smart cards, CD-ROM, digital versatile disks (DVD) or other optical storage, magnetic tape, magnetic disk storage or other magnetic storage devices, universal serial bus (USB) compatible memory, or any other medium which can be used to store information and which can be accessed by the controller 137. The HMI device 141 can include inputs that provide the ability to control the controller 137, via, for example, buttons, soft keys, a mouse, voice actuated controls, a touch screen, movement of the controller 137, visual cues (e.g., moving a hand in front of a camera on the controller 137), or the like. The HMI device 141 can provide outputs, via a graphical user interface, including visual information, such as the visual indication of the current pressure values of the gas, hot melt adhesive, and/or the solution, as well as acceptable ranges for these parameters via a display. Other outputs can include audio information (e.g., via speaker), mechanically (e.g., via a vibrating mechanism), or a combination thereof. In various configurations, the HMI device 141 can include a display, a touch screen, a keyboard, a mouse, a motion detector, a speaker, a microphone, a camera, or any combination thereof. The HMI device 141 can further include any suitable device for inputting biometric information, such as, for example, fingerprint information, retinal information, voice information, and/or facial characteristic information, for instance, so as to require specific biometric information for accessing the controller 137.

The controller 137 can be in signal communication with various components of the dispensing system 101 so as to receive signals from and/or provide instructions to each component. The controller 137 can be in signal communication with the gear flow meter 100 through first signal connection 196, the gas valve 194 through a second signal connection 197, the pump 111 through a third signal connection 198, and the temperature sensor 156 through a fourth signal connection 199. Each of the first signal connection 196, the second signal connection 197, the third signal connection 198, and the fourth signal connection 199 can comprise wired and/or wireless connections.

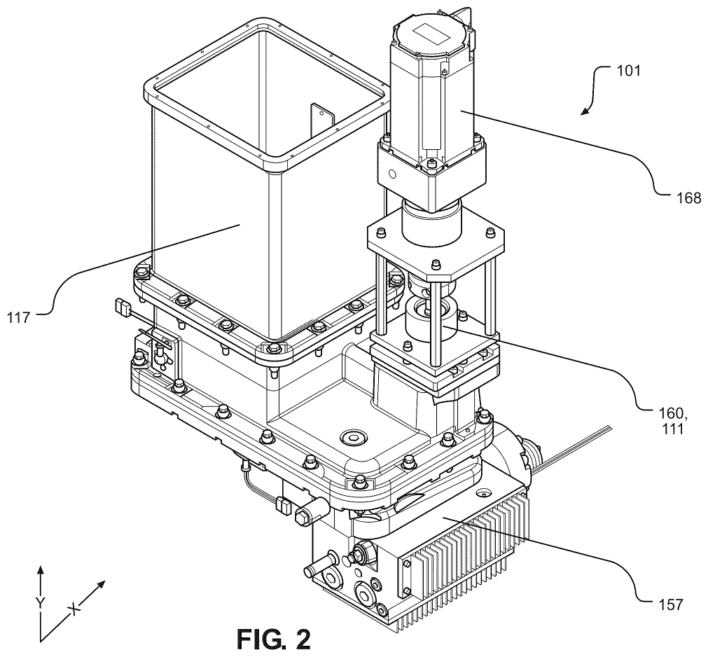

FIG. 2 illustrates a perspective view of an exemplary implementation of the dispensing system according to aspects of the disclosure.

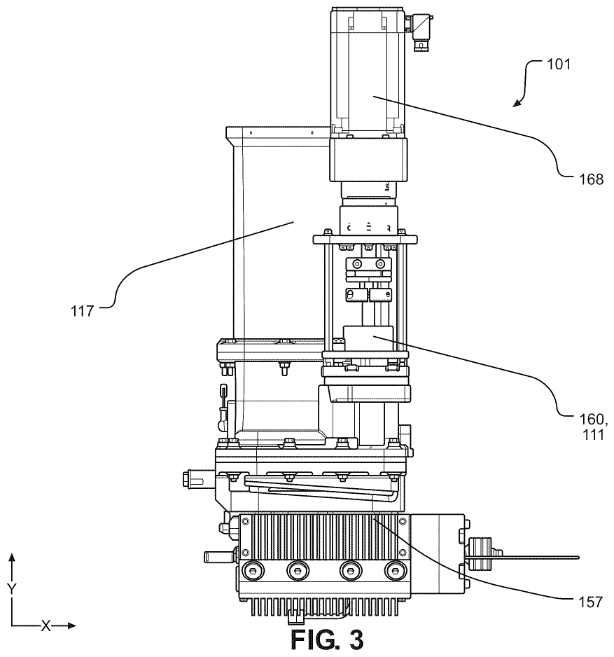

FIG. 3 illustrates a front view of an exemplary implementation of the dispensing system according to FIG. 2.

In particular, FIG. 2 and FIG. 3 may include any other aspects of the dispensing system 101 illustrated and/or described herein. Further, the aspects illustrated in FIG. 2 and FIG. 3 may be implemented in any other aspects of the dispensing system 101 set forth in this disclosure. Further, FIG. 2 and FIG. 3 illustrate exemplary locations of the motor 168, the adhesive source 117, the impeller device 160, the pump 111, the heat exchanger 157, and/or the like implemented by the dispensing system 101 disclosed herein.

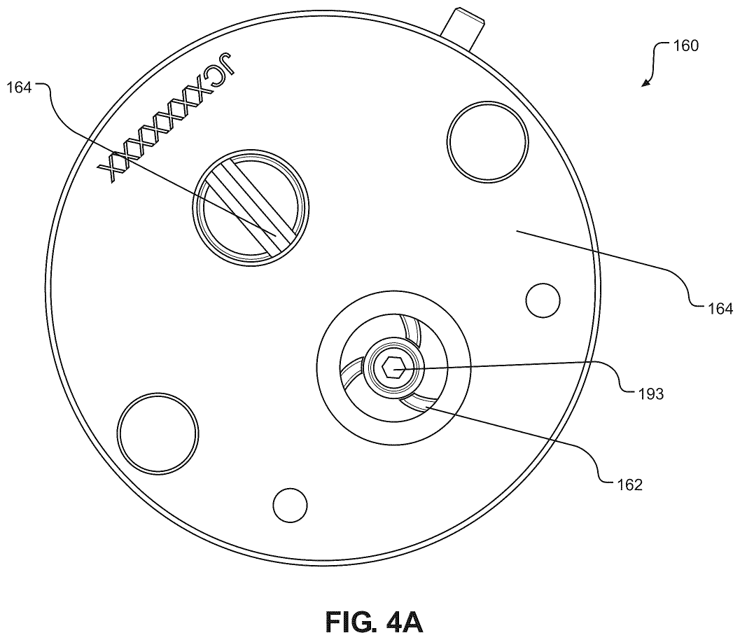

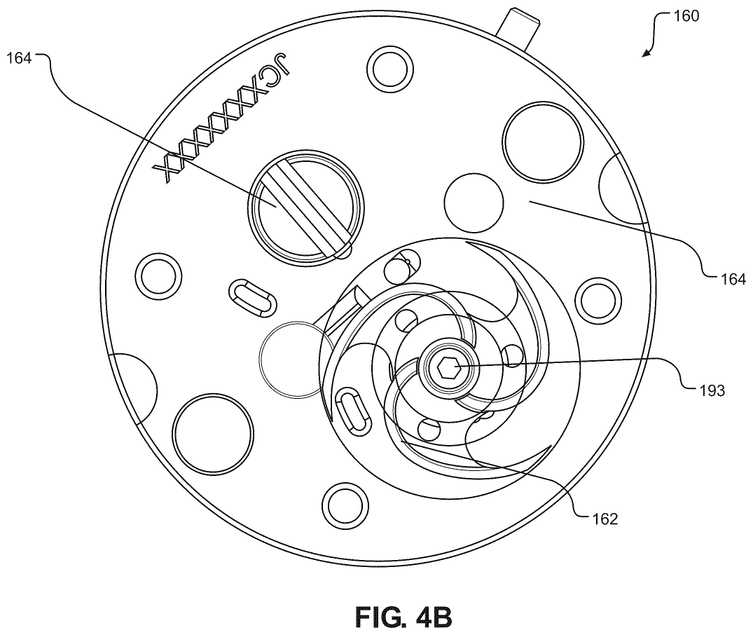

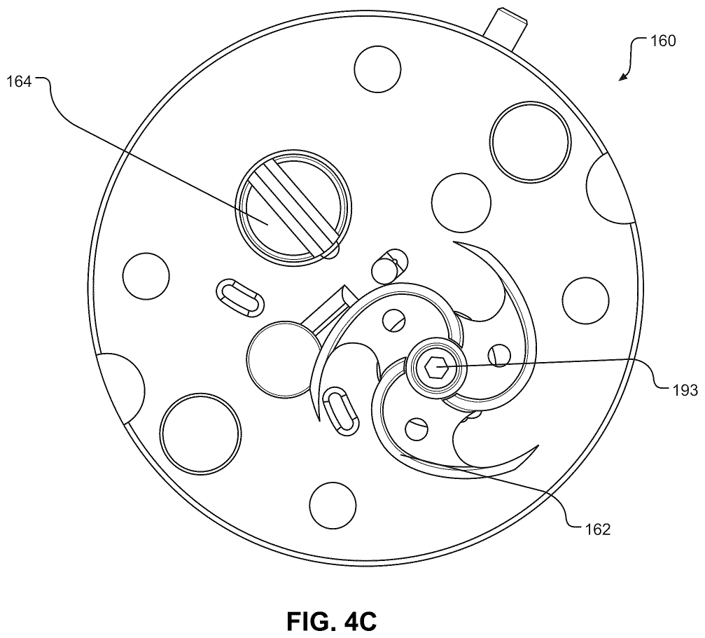

FIG. 4, which includes FIG. 4A, FIG. 4B, and FIG. 4C, illustrates a top view of an exemplary implementation of the impeller according to aspects of the disclosure.

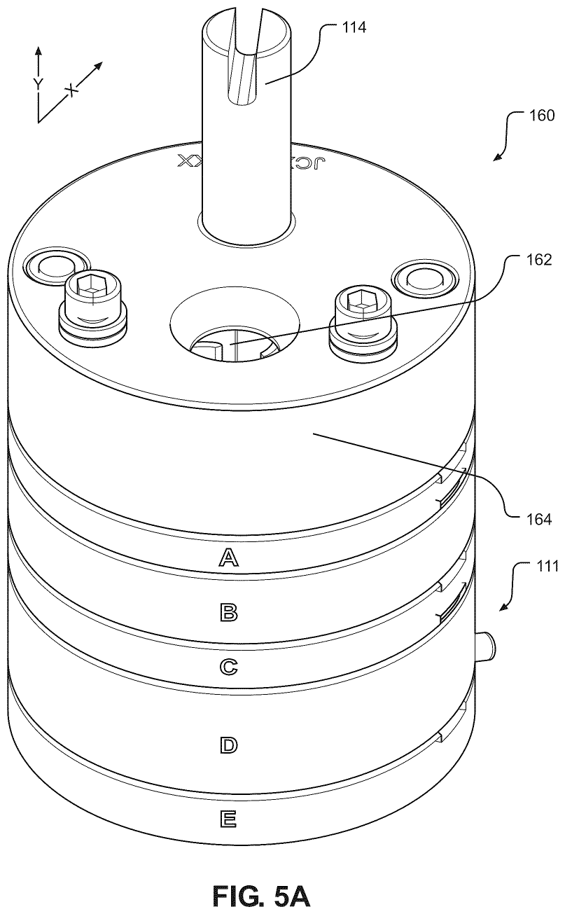

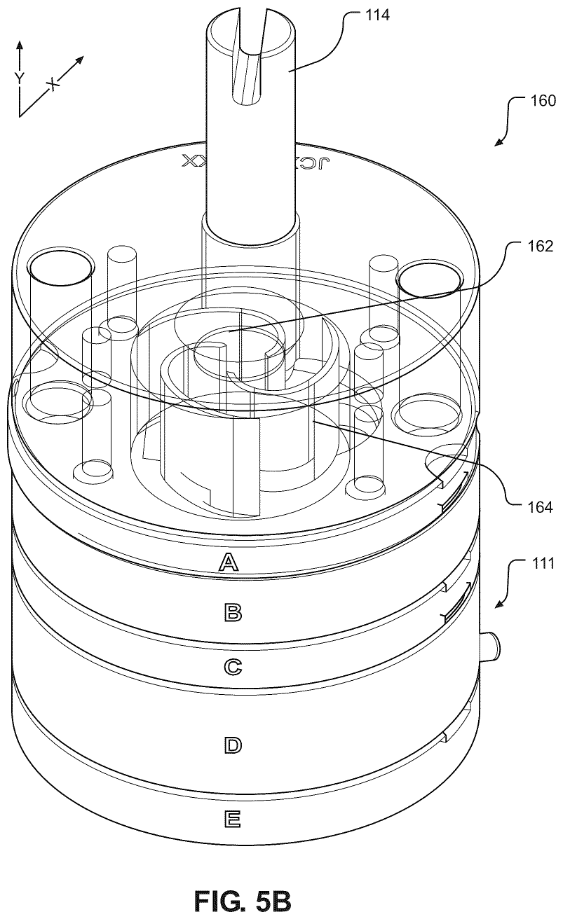

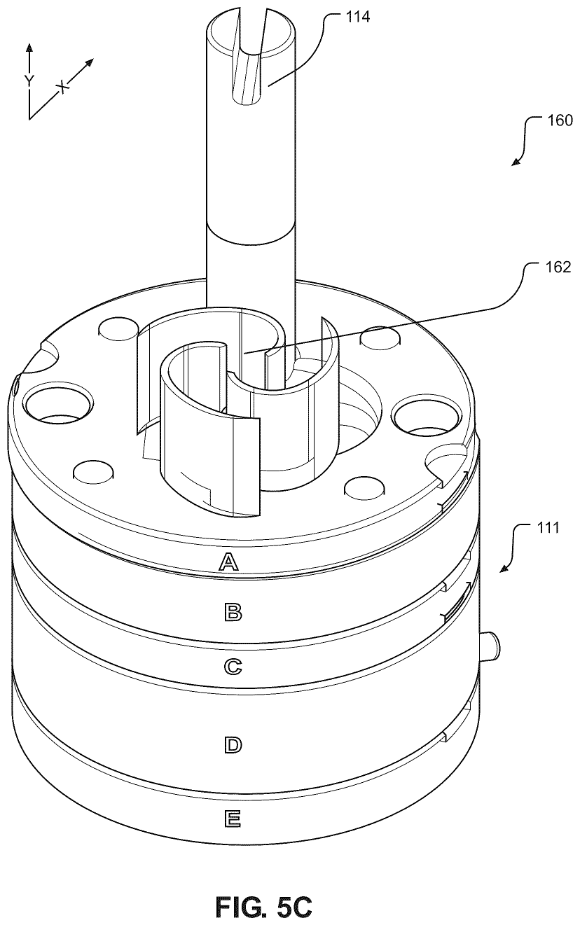

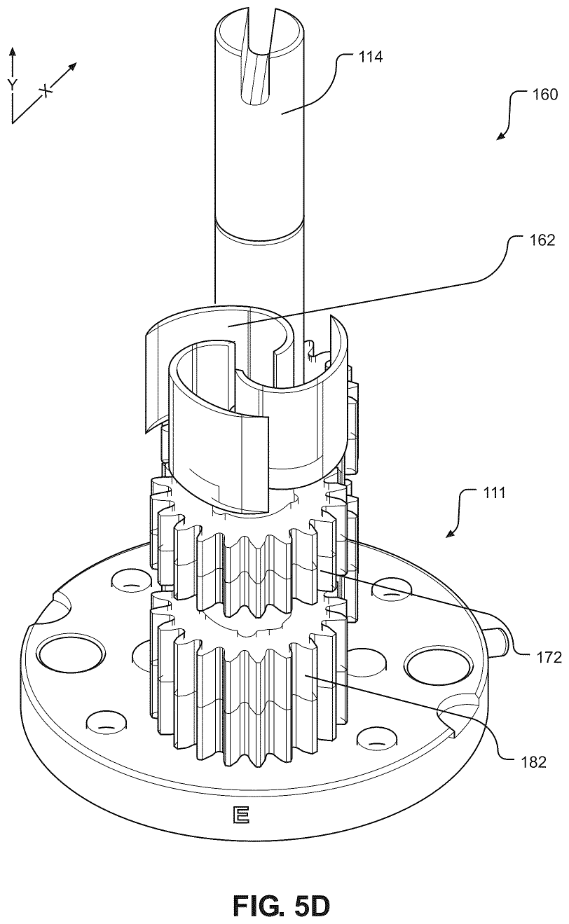

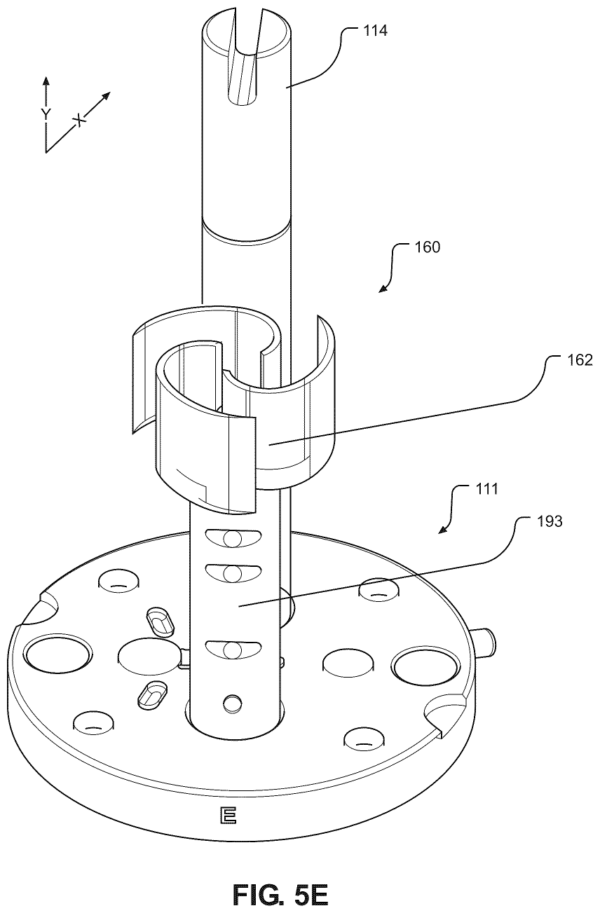

FIG. 5, which includes FIG. 5A, FIG. 5B, FIG. 5C, FIG. 5D, and FIG. 5E illustrates a front perspective view of an exemplary implementation of the impeller according to FIG. 4.

In particular, FIG. 4 and FIG. 5 may include any other aspects of the dispensing system 101 illustrated and/or described herein. Further, the aspects illustrated in FIG. 4 and FIG. 5 may be implemented in any other aspects of the dispensing system 101 set forth in this disclosure. Further, FIG. 4 and FIG. 5 illustrate exemplary implementations of the impeller device 160 and/or the like implemented by the dispensing system 101 disclosed herein.

As illustrated in FIG. 4, the impeller device 160 may include an impeller 162. The impeller 162 may be arranged in an impeller housing 164. Further, the impeller 162 may be operatively attached to the common idler shaft 193. Moreover, the impeller 162 of the impeller device 160 may be driven by the common idler shaft 193. In particular, FIG. 4A illustrates the impeller device 160 with the impeller housing 164 attached; FIG. 4B illustrates the impeller device 160 with the impeller housing 164 illustrated as transparent; and FIG. 4C illustrates the impeller device 160 with the impeller housing 164 removed for clarity of understanding.

With reference to FIG. 5, the impeller device 160, including the impeller housing 164 may be arranged above the pump 111. More specifically, FIG. 5A illustrates an external configuration of the impeller device 160; FIG. 5B illustrates an external configuration of the impeller device 160 with the impeller housing 164 illustrated as transparent; FIG. 5C illustrates an external configuration of the impeller device 160 with the impeller housing 164 removed for clarity of understanding; FIG. 5D illustrates an external configuration of the impeller device 160 with the impeller housing 164 removed and a housing of the pump 111 removed for clarity of understanding; and FIG. 5E illustrates an external configuration of the impeller device 160 with the impeller housing 164 removed, the housing of the pump 111 removed, and the gears of the pump 111 removed for clarity of understanding.

FIG. 6 illustrates a perspective view of an exemplary implementation of the dispensing system with details of the heat exchanger according to aspects of the disclosure.

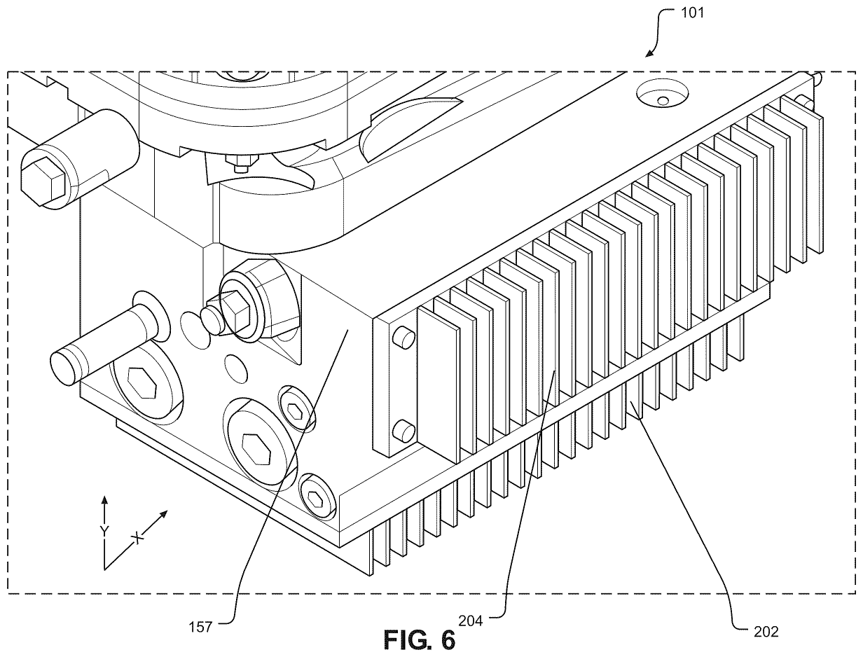

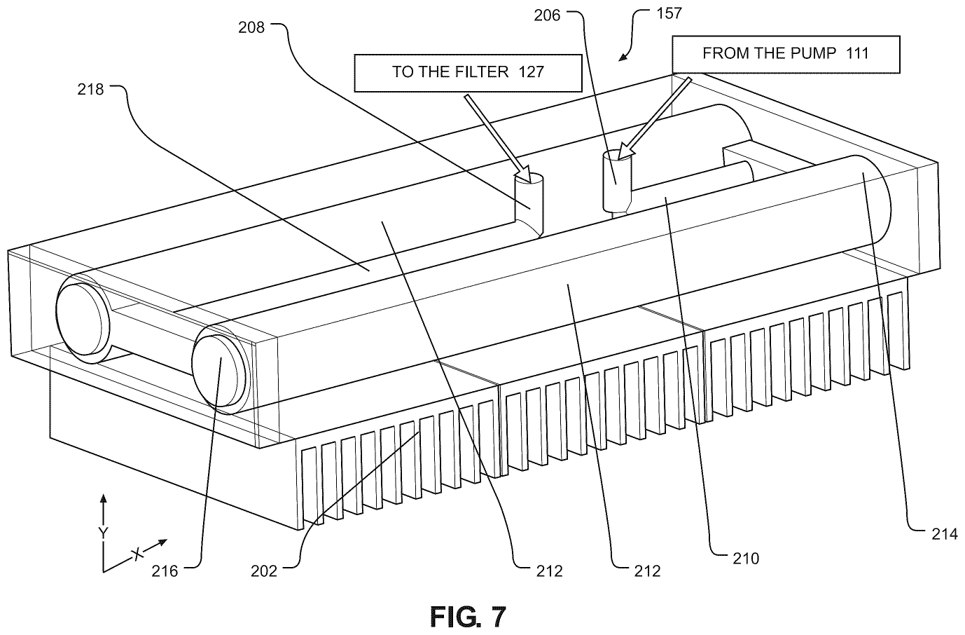

FIG. 7 illustrates an internal perspective view of an exemplary implementation of the dispensing system with details of the heat exchanger according to FIG. 6.

In particular, FIG. 6 and FIG. 7 may include any other aspects of the dispensing system 101 illustrated and/or described herein. Further, the aspects illustrated in FIG. 6 and FIG. 7 may be implemented in any other aspects of the dispensing system 101 set forth in this disclosure. Further, FIG. 6 and FIG. 7 illustrate exemplary implementations of the heat exchanger 157.

As illustrated in FIG. 6, the heat exchanger 157 may be arranged on a lower and of the dispensing system 101. Further, the heat exchanger 157 may be arranged in a manifold and/or include a manifold. Further, the heat exchanger 157 may include lower heat fins 202; and the heat exchanger 157 may include side heat fins 204.

With reference to FIG. 7, the heat exchanger 157 may include a heat exchanger inlet 206 configured and arranged to receive hot melt adhesive from the pump 111 or other component of the dispensing system 101; and the heat exchanger 157 may include a heat exchanger outlet 208 configured and arranged to output hot melt adhesive to the filter 127 or other component of the dispensing system 101. Further, the heat exchanger 157 may include at least one heat exchange tube 212. In aspects, the heat exchanger 157 is implemented with two implementations of the at least one heat exchange tube 212. However, any number of implementations of the at least one heat exchange tube 212 by the heat exchanger 157 is contemplated by the disclosure.

Further, the heat exchanger 157 may include a first heat exchanger conduit 210 extending from the heat exchanger inlet 206 to a first end 214 of the at least one heat exchange tube 212. Accordingly, hot melt adhesive received from the pump 111 may enter the heat exchanger inlet 206 be guided by the first heat exchanger conduit 210 to the first end 214 of the at least one heat exchange tube 212. Thereafter, the hot melt adhesive may be guided from the first end 214 of the at least one heat exchange tube 212 to a second end 216 of the at least one heat exchange tube 212. During the movement of the hot melt adhesive within the at least one heat exchange tube 212 from the first end 214 to the second end 216, heat may be transferred from the hot melt adhesive through the at least one heat exchange tube 212 and to the lower heat fins 202 and/or the side heat fins 204.

Once the hot melt adhesive reaches the second end 216 of the at least one heat exchange tube 212, the hot melt adhesive may enter a second heat exchanger conduit 218. Thereafter, the hot melt adhesive may be guided by the second heat exchanger conduit 218 to the heat exchanger outlet 208; subsequently the hot melt adhesive may be guided from the heat exchanger outlet 208 to the filter 127 or other component of the dispensing system 101.

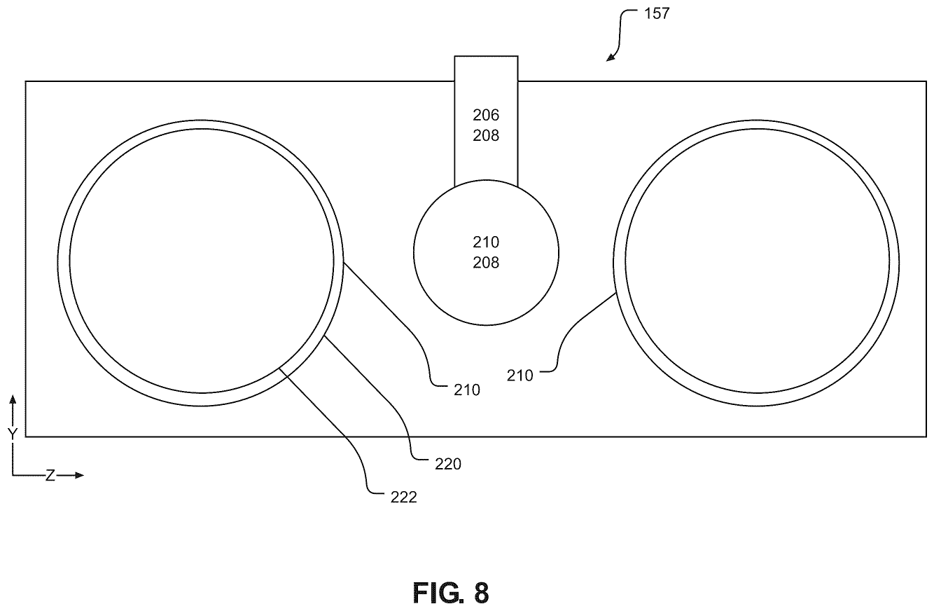

FIG. 8 illustrates a cross-sectional view of an exemplary implementation of the heat exchanger according to aspects of the disclosure.

In particular, FIG. 8 may include any other aspects of the dispensing system 101 illustrated and/or described herein. Further, the aspects illustrated in FIG. 8 may be implemented in any other aspects of the dispensing system 101 set forth in this disclosure. Further, FIG. 8 illustrates exemplary implementations of the heat exchanger 157.

With reference to FIG. 8, the at least one heat exchange tube 212 of the heat exchanger 157 may include a heat exchange tube outer wall 220 and a heat exchange inner wall 222. In this regard, the hot melt adhesive may flow between the heat exchange tube outer wall 220 and the heat exchange inner wall 222. In this regard, minimizing an area for the hot melt adhesive to flow, in this case, between the heat exchange tube outer wall 220 and the heat exchange inner wall 222, may increase transfer of heat from the hot melt adhesive to the heat exchanger 157. Moreover, the heat exchange tube outer wall 220 and the heat exchange inner wall 222 may transfer heat from the hot melt adhesive to the lower heat fins 202 and/or the side heat fins 204 of the heat exchanger 157.

In aspects, the heat exchange tube outer wall 220 and the heat exchange inner wall 222 may provide an increased heat transfer surface with respect to the flow rate of the solution therein. In aspects, the heat exchange inner wall 222 may be formed as an insert that is inserted within the 212. In aspects, the heat exchange inner wall 222 may be formed as a cylindrical insert that is arranged within the 212.

In aspects, the at least one heat exchange tube 212 and/or the heat exchange tube outer wall 220 may have a diameter of 0.5 inches to 4.0 inches, 1.0 inches to 2.0 inches, 1.2 inches to 1.7 inches, 2.0 inches to 3.0 inches, or 3.0 inches to 4.0 inches. The diameter of the at least one heat exchange tube 212 and/or the heat exchange tube outer wall 220 may provide more effective and/or more efficient transfer of heat from the hot melt adhesive to the heat exchanger 157. In aspects, the transfer of heat from the hot melt adhesive to the disclosed implementation of the heat exchanger 157 was unexpected and surprising.

In aspects, a distance between the heat exchange inner wall 222 and/or the heat exchange tube outer wall 220 may be 0.02 inches to 0.15 inches, 0.02 inches to 0.05 inches, 0.05 inches to 0.9 inches, 0.9 inches to 0.10 inches, or 0.10 inches to 0.15 inches. The distance between the heat exchange inner wall 222 and/or the heat exchange tube outer wall 220 may provide more effective and/or more efficient transfer of heat from the hot melt adhesive to the heat exchanger 157. In aspects, the transfer of heat from the hot melt adhesive to the disclosed implementation of the heat exchanger 157 was unexpected and surprising.

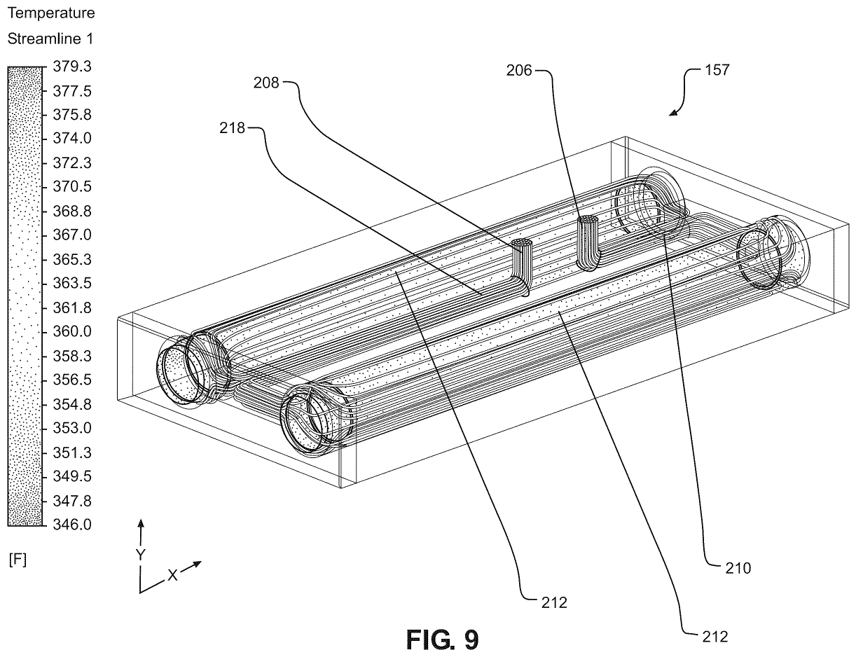

FIG. 9 illustrates a temperature of the solution in the heat exchanger implemented according to the disclosure.

In particular, FIG. 9 illustrates a temperature of the solution in the heat exchanger 157 implemented according to the disclosure. In this regard, FIG. 9 illustrates that the temperature of the solution at the heat exchanger inlet 206 was approaching 379° F.; and the solution output from the heat exchanger outlet 208 was approaching 350° F. In this regard, other configurations of the dispensing system 101 implementing different settings may likely have similar amounts of temperature decrease. In aspects, the heat exchanger 157 implemented according to the disclosure may decrease temperature at least 10° F., 20° F., 30° F., or 40° F.

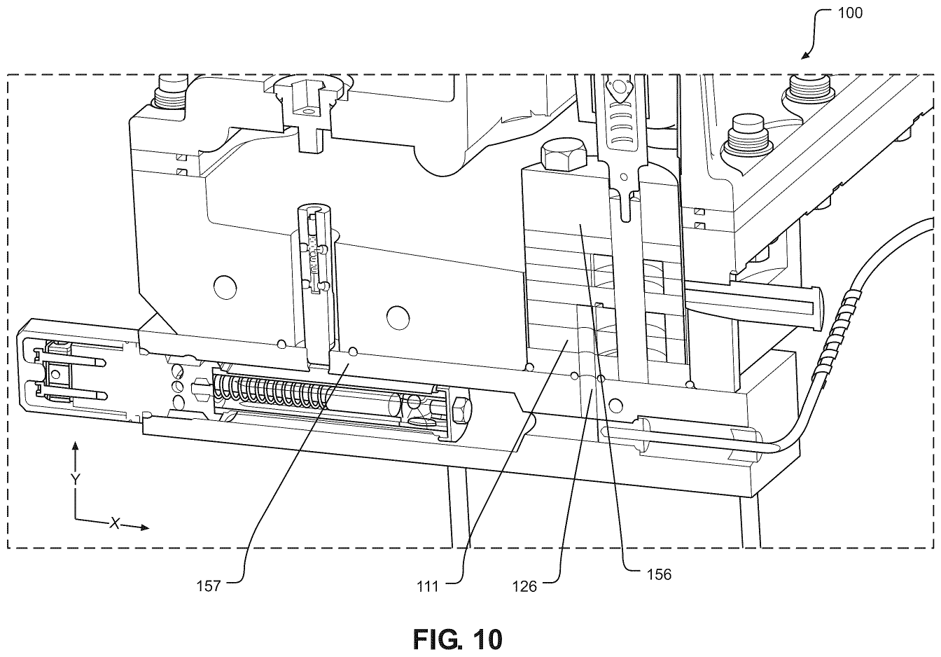

FIG. 10 illustrates a perspective view of an exemplary implementation of the dispensing system with details of the temperature sensor according to aspects of the disclosure.

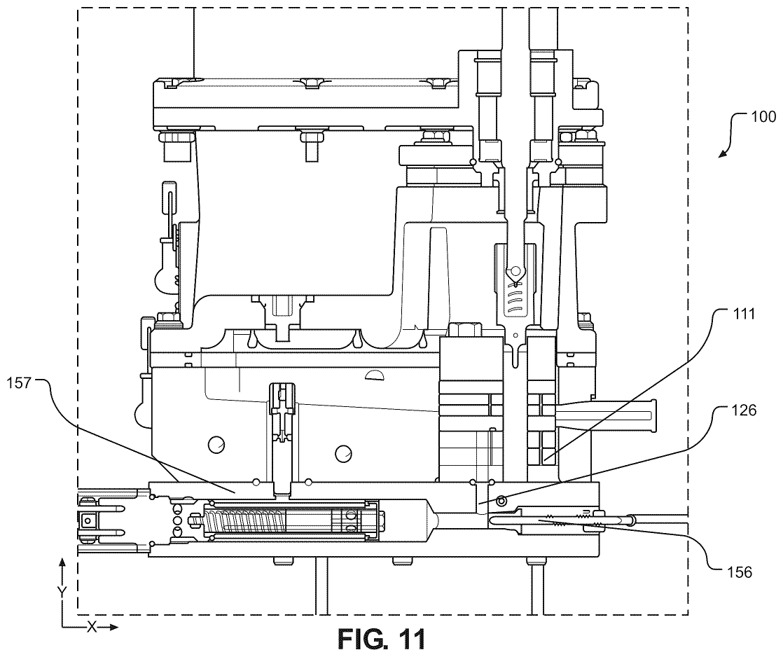

FIG. 11 illustrates a front view of an exemplary implementation of the dispensing system with details of the temperature sensor according to FIG. 10.

In particular, FIG. 10 and FIG. 11 may include any other aspects of the dispensing system 101 illustrated and/or described herein. Further, the aspects illustrated in FIG. 10 and FIG. 11 may be implemented in any other aspects of the dispensing system 101 set forth in this disclosure. Further, FIG. 10 and FIG. 11 illustrate exemplary implementations of the dispensing system 101 with details of the temperature sensor 156.

In this regard, the solution after exiting the outlet 126 of the dispensing system 101, may enter a manifold that may be part of the heat exchanger 157. Between the outlet 126 and the heat exchanger 157 may be arranged the temperature sensor 156. Accordingly, the temperature sensor 156 may be in fluid communication with the solution and can be configured to detect a temperature of the solution. In the depicted aspect, the temperature sensor 156 can be positioned adjacent the outlet 126 of the second stage 113, though other positions are contemplated. Additionally, the temperature sensor 156 may be configured and located to control heat rise within the dispensing system 101 to within a few degrees of set point with assistance from forced convection cooling of manifold heat sink and/or the heat exchanger 157. Accordingly, the dispensing system 101 may further include a forced convection cooling device. In particular, the forced convection cooling device may be implemented by the dispensing system 101 in conjunction with the temperature sensor 156.

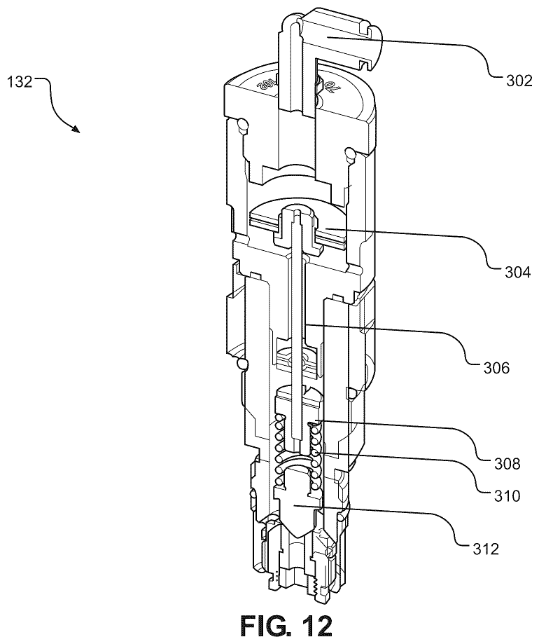

FIG. 12 illustrates a cross-sectional view of an exemplary implementation of the dispenser valve according to aspects of the disclosure.

In particular, FIG. 12 may include any other aspects of the dispensing system 101 illustrated and/or described herein. Further, the aspects illustrated in FIG. 12 may be implemented in any other aspects of the dispensing system 101 set forth in this disclosure. Further, FIG. 12 illustrates exemplary implementations of the dispenser valve 132.

With reference to FIG. 12, the dispenser valve 132 may be implemented as a pressure control valve. The dispenser valve 132 may provide improved regulation over current filesystems. Moreover, the dispenser valve 132 may be implemented as a pneumatically controlled valve. Further, the dispenser valve 132 has demonstrated performance that is six times performance improvement.

In aspects, the dispenser valve 132 may include a pneumatic connection 302 configured to receive air for operation of the dispenser valve 132. Additionally, the dispenser valve 132 may include a diaphragm 304 operative to move in response to air received from the pneumatic connection 302. Movement of the diaphragm 304 results in movement of a valve rod 306 and subsequent movement of a plunger 308. Further, the dispenser valve 132 may include a spring 310 and a valve element 312. The spring 310 may be arranged between the plunger 308 and the valve element 312. Accordingly, the dispenser valve 132 may operate to receive air from the pneumatic connection 302, which moves the diaphragm 304, the valve rod 306, the plunger 308, and the valve element 312.

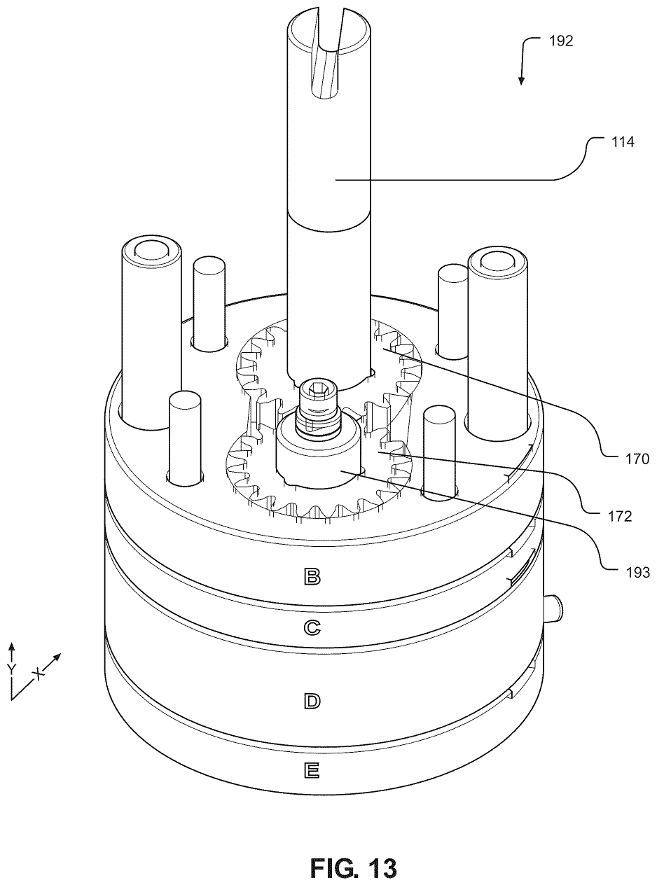

FIG. 13 illustrates a cross-sectional view of an exemplary implementation of the first stage according to aspects of the disclosure.

In particular, FIG. 13 may include any other aspects of the dispensing system 101 illustrated and/or described herein. Further, the aspects illustrated in FIG. 13 may be implemented in any other aspects of the dispensing system 101 set forth in this disclosure. Further, FIG. 13 illustrates exemplary implementations of the first stage 192.

With reference to FIG. 13, the first stage 192 may be implemented in a housing between the impeller device 160 and the second stage 113. The housing may support the first gear 170 and the second gear 172. In particular, the housing may receive the common drive shaft 114 and the first gear 170 may rotate in conjunction with rotation of the common drive shaft 114. Further, the housing may receive the common idler shaft 193 and the second gear 172 may rotate in conjunction with rotation of the common idler shaft 193.

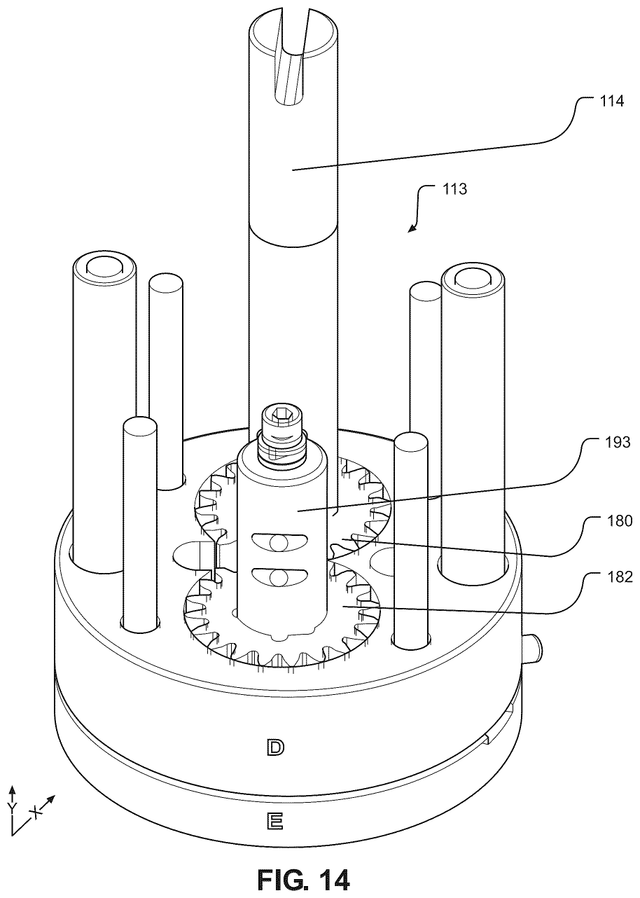

FIG. 14 illustrates a cross-sectional view of an exemplary implementation of the second stage according to aspects of the disclosure.

In particular, FIG. 14 may include any other aspects of the dispensing system 101 illustrated and/or described herein. Further, the aspects illustrated in FIG. 14 may be implemented in any other aspects of the dispensing system 101 set forth in this disclosure. Further, FIG. 14 illustrates exemplary implementations of the second stage 113.

With reference to FIG. 14, the second stage 113 may be implemented in a housing below the first stage 192. The housing may support the first gear 180 and the second gear 182. In particular, the housing may receive the common drive shaft 114 and the first gear 180 may rotate in conjunction with rotation of the common drive shaft 114. Further, the housing may receive the common idler shaft 193 and the second gear 182 may rotate in conjunction with rotation of the common idler shaft 193.

Accordingly, the disclosure has set forth a hot melt adhesive foam dispensing system having improved performance. Further, the disclosure has set forth a hot melt adhesive foam dispensing system having improved performance that addresses the deficiencies described above.

The following are a number of nonlimiting EXAMPLES of aspects of the disclosure.

One EXAMPLE includes: a dispensing system that includes an impeller device configured to receive a hot melt adhesive; a pump having a first input configured to receive the hot melt adhesive and a second input configured to receive a gas, where the pump is configured to mix the hot melt adhesive and the gas to produce a solution and pump the solution at a volumetric flow rate; a valve configured to control an amount of the gas provided to the pump through the second input; and a dispenser configured to receive the solution from the pump and dispense the solution to create the hot melt adhesive foam.

The above-noted EXAMPLE may further include any one or a combination of more than one of the following EXAMPLES: The dispensing system of the above-noted EXAMPLE where the impeller device is configured to improve efficiency. The dispensing system of the above-noted EXAMPLE where the impeller device is configured to improve output rate of the dispensing system. The dispensing system of the above-noted EXAMPLE where the impeller device is configured to improve capture gas from a recirculation system. The dispensing system of the above-noted EXAMPLE where the impeller device is configured and/or implemented as a semi open impeller driven by common idler shaft. The dispensing system of the above-noted EXAMPLE where the impeller device is configured to be implemented as a pump inlet priming impeller. The dispensing system of the above-noted EXAMPLE where the impeller device is configured to increase mix energy. The dispensing system of the above-noted EXAMPLE where the impeller device is configured to reduce heat rise due to increased pump efficiency. The dispensing system of the above-noted EXAMPLE where the impeller device may include an impeller. The dispensing system of the above-noted EXAMPLE where the impeller is arranged in an impeller housing. The dispensing system of the above-noted EXAMPLE where the controller may include a PID controller. The dispensing system of the above-noted EXAMPLE where the controller may include a proportional controller. The dispensing system of the above-noted EXAMPLE may include: a hot melt adhesive source configured to provide the hot melt adhesive to the first input.

The dispensing system of the above-noted EXAMPLE may include: a gas source configured to provide the gas to the second input. The dispensing system of the above-noted EXAMPLE may include: a filter fluidly disposed between the pump and the flow meter. The dispensing system of the above-noted EXAMPLE may include: a recirculation channel configured to selectively direct the solution from a dispenser to the pump. The dispensing system of the above-noted EXAMPLE may include a temperature sensor arranged between an outlet and a heat exchanger. The dispensing system of the above-noted EXAMPLE where the temperature sensor is configured and located to control heat rise within the dispensing system. The dispensing system of the above-noted EXAMPLE may include a heat exchanger arranged in a manifold and/or includes a manifold. The dispensing system of the above-noted EXAMPLE where the heat exchanger may include lower heat fins; and where the heat exchanger may include side heat fins. The dispensing system of the above-noted EXAMPLE where the heat exchanger may include lower heat fins. The dispensing system of the above-noted EXAMPLE where the heat exchanger may include side heat fins. The dispensing system of the above-noted EXAMPLE where the heat exchanger may include a heat exchanger inlet is configured and arranged to receive hot melt adhesive from the pump or other component of the dispensing system. The dispensing system of the above-noted EXAMPLE where the heat exchanger may include at least one heat exchange tube. The dispensing system of the above-noted EXAMPLE where the heat exchanger is implemented with two implementations of the at least one heat exchange tube. The dispensing system of the above-noted EXAMPLE where the heat exchanger may include a first heat exchanger conduit extending from the heat exchanger inlet to a first end of the at least one heat exchange tube. The dispensing system of the above-noted EXAMPLE where the at least one heat exchange tube of the heat exchanger may include a heat exchange tube outer wall and a heat exchange inner wall. The dispensing system of the above-noted EXAMPLE where the hot melt adhesive may flow between the heat exchange tube outer wall and the heat exchange inner wall. The dispensing system of the above-noted EXAMPLE where the heat exchange inner wall is formed as a cylindrical insert. The dispensing system of the above-noted EXAMPLE may include a temperature sensor arranged between an outlet and a heat exchanger. The dispensing system of the above-noted EXAMPLE where the heat exchanger may include a heat exchanger outlet is configured and arranged to output hot melt adhesive to a filter or other component of the dispensing system. The dispensing system of the above-noted EXAMPLE may include a dispenser valve being configured to be implemented as a pneumatically controlled valve. The dispensing system of the above-noted EXAMPLE where the dispenser valve may include a pneumatic connection configured to receive air for operation of the dispenser valve. The dispensing system of the above-noted EXAMPLE where the dispenser valve may include a diaphragm operative to move in response to air received from the pneumatic connection.

One EXAMPLE includes: a method that includes receiving a hot melt adhesive to an impeller device from a hot melt adhesive source. The method in addition includes receiving a gas from a gas source. The method moreover includes mixing the hot melt adhesive and the gas to produce a solution. The method also includes pumping the solution from a pump to a dispenser at a volumetric flow rate. The method in addition includes dispensing the solution to create the hot melt adhesive foam.

The above-noted EXAMPLE may further include any one or a combination of more than one of the following EXAMPLES: The method of the above-noted EXAMPLE where the impeller device is configured to improve efficiency. The method of the above-noted EXAMPLE where the impeller device is configured to improve output rate of a dispensing system. The method of the above-noted EXAMPLE where the impeller device is configured to improve capture gas from a recirculation system. The method of the above-noted EXAMPLE where the impeller device is configured and/or implemented as a semi open impeller driven by common idler shaft. The method of the above-noted EXAMPLE where the impeller device is configured to be implemented as a pump inlet priming impeller. The method of the above-noted EXAMPLE where the impeller device is configured to increase mix energy. The method of the above-noted EXAMPLE where the impeller device is configured to reduce heat rise due to increased pump efficiency. The method of the above-noted EXAMPLE where the impeller device may include an impeller. The method of the above-noted EXAMPLE where the impeller is arranged in an impeller housing.

One EXAMPLE includes: a dispensing system that includes a heat exchanger arranged in a manifold and/or includes a manifold. The dispensing system in addition includes a pump having a first input configured to receive a hot melt adhesive and a second input configured to receive a gas, where the pump is configured to mix the hot melt adhesive and the gas to produce a solution and pump the solution at a volumetric flow rate; a valve configured to control an amount of the gas provided to the pump through the second input; and a dispenser configured to receive the solution from the pump and dispense the solution to create the hot melt adhesive foam.

The above-noted EXAMPLE may further include any one or a combination of more than one of the following EXAMPLES: The dispensing system of the above-noted EXAMPLE where the heat exchanger may include lower heat fins; and where the heat exchanger may include side heat fins. The dispensing system of the above-noted EXAMPLE where the heat exchanger may include lower heat fins. The dispensing system of the above-noted EXAMPLE where the heat exchanger may include side heat fins. The dispensing system of the above-noted EXAMPLE where the heat exchanger may include a heat exchanger inlet is configured and arranged to receive hot melt adhesive from the pump or other component of the dispensing system. The dispensing system of the above-noted EXAMPLE where the heat exchanger may include at least one heat exchange tube. The dispensing system of the above-noted EXAMPLE where the heat exchanger is implemented with two implementations of the at least one heat exchange tube. The dispensing system of the above-noted EXAMPLE where the heat exchanger may include a first heat exchanger conduit extending from the heat exchanger inlet to a first end of the at least one heat exchange tube. The dispensing system of the above-noted EXAMPLE where the at least one heat exchange tube of the heat exchanger may include a heat exchange tube outer wall and a heat exchange inner wall. The dispensing system of the above-noted EXAMPLE where the hot melt adhesive may flow between the heat exchange tube outer wall and the heat exchange inner wall. The dispensing system of the above-noted EXAMPLE where the heat exchange inner wall is formed as a cylindrical insert. The dispensing system of the above-noted EXAMPLE may include a temperature sensor arranged between an outlet and a heat exchanger. The dispensing system of the above-noted EXAMPLE where the temperature sensor is configured and located to control heat rise within the dispensing system. The dispensing system of the above-noted EXAMPLE may include a dispenser valve being configured to be implemented as a pneumatically controlled valve. The dispensing system of the above-noted EXAMPLE where the dispenser valve may include a pneumatic connection configured to receive air for operation of the dispenser valve. The dispensing system of the above-noted EXAMPLE where the dispenser valve may include a diaphragm operative to move in response to air received from the pneumatic connection. The dispensing system of the above-noted EXAMPLE where a movement of the diaphragm results in movement of a valve rod and subsequent movement of a plunger. The dispensing system of the above-noted EXAMPLE where the dispenser valve may include a spring and a valve element. The dispensing system of the above-noted EXAMPLE may include an impeller device configured to receive a hot melt adhesive. The dispensing system of the above-noted EXAMPLE where the impeller device is configured to improve efficiency. The dispensing system of the above-noted EXAMPLE where the impeller device is configured to improve output rate of the dispensing system. The dispensing system of the above-noted EXAMPLE where the impeller device is configured to improve capture gas from a recirculation system. The dispensing system of the above-noted EXAMPLE where the impeller device is configured and/or implemented as a semi open impeller driven by common idler shaft. The dispensing system of the above-noted EXAMPLE where the impeller device is configured to be implemented as a pump inlet priming impeller. The dispensing system of the above-noted EXAMPLE where the impeller device is configured to increase mix energy. The dispensing system of the above-noted EXAMPLE where the impeller device is configured to reduce heat rise due to increased pump efficiency. The dispensing system of the above-noted EXAMPLE where the impeller device may include an impeller. The dispensing system of the above-noted EXAMPLE where the impeller is arranged in an impeller housing. The dispensing system of the above-noted EXAMPLE where the heat exchanger may include a heat exchanger outlet is configured and arranged to output hot melt adhesive to a filter or other component of the dispensing system. The dispensing system of the above-noted EXAMPLE where the controller may include a PID controller. The dispensing system of the above-noted EXAMPLE where the controller may include a proportional controller. The dispensing system of the above-noted EXAMPLE may include: a hot melt adhesive source configured to provide the hot melt adhesive to the first input. The dispensing system of the above-noted EXAMPLE may include: a gas source configured to provide the gas to the second input. The dispensing system of the above-noted EXAMPLE may include: a filter fluidly disposed between the pump and the flow meter. The dispensing system of the above-noted EXAMPLE may include: a recirculation channel configured to selectively direct the solution from a dispenser to the pump.

One EXAMPLE includes: a method that includes receiving a hot melt adhesive to an impeller device from a hot melt adhesive source. The method in addition includes receiving a gas from a gas source. The method moreover includes mixing the hot melt adhesive and the gas to produce a solution. The method also includes pumping the solution from a pump to a dispenser at a volumetric flow rate; lowering a temperature of the hot melt adhesive with a heat exchanger arranged in a manifold and/or includes a manifold; and dispensing the solution to create the hot melt adhesive foam.

The above-noted EXAMPLE may further include any one or a combination of more than one of the following EXAMPLES: The method of the above-noted EXAMPLE where the heat exchanger may include lower heat fins; and where the heat exchanger may include side heat fins. The method of the above-noted EXAMPLE where the heat exchanger may include lower heat fins. The method of the above-noted EXAMPLE where the heat exchanger may include side heat fins. The method of the above-noted EXAMPLE where the heat exchanger may include a heat exchanger inlet is configured and arranged to receive hot melt adhesive from the pump or other component of the method. The method of the above-noted EXAMPLE where the heat exchanger may include at least one heat exchange tube. The method of the above-noted EXAMPLE where the heat exchanger is implemented with two implementations of the at least one heat exchange tube. The method of the above-noted EXAMPLE where the heat exchanger may include a first heat exchanger conduit extending from the heat exchanger inlet to a first end of the at least one heat exchange tube. The method of the above-noted EXAMPLE where the at least one heat exchange tube of the heat exchanger may include a heat exchange tube outer wall and a heat exchange inner wall. The method of the above-noted EXAMPLE where the hot melt adhesive may flow between the heat exchange tube outer wall and the heat exchange inner wall. The method of the above-noted EXAMPLE where the heat exchange inner wall is formed as a cylindrical insert. The method of the above-noted EXAMPLE where the heat exchanger may include a heat exchanger outlet is configured and arranged to output hot melt adhesive to a filter or other component of the method.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

While various inventive aspects, concepts and features of the inventions may be described and illustrated herein as embodied in combination in the exemplary aspects, these various aspects, concepts and features may be used in many alternative aspects, either individually or in various combinations and sub-combinations thereof. Unless expressly excluded herein all such combinations and sub-combinations are intended to be within the scope of the present inventions. Still further, while various alternative aspects as to the various aspects, concepts, and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative aspects, whether presently known or later developed. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the disclosure; however, such values and ranges are not to be construed in a limiting sense and are intended to be critical values or ranges only if so expressly stated. Moreover, while various aspects, features, and concepts may be expressly identified herein as being inventive or forming part of an invention, such identification is not intended to be exclusive, but rather there may be inventive aspects, concepts, and features that are fully described herein without being expressly identified as such or as part of a specific invention, the scope of the inventions instead being set forth in the appended claims or the claims of related or continuing applications. Descriptions of exemplary methods or processes are not limited to inclusion of all steps as being required in all cases, nor is the order that the steps are presented to be construed as required or necessary unless expressly so stated. For instance, although the steps of the methods are described with reference to sequential series of reference signs and progression of the blocks in the figures, the method can be implemented in a particular order as desired.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. A dispensing system for dispensing hot melt adhesive foam onto a substrate, the dispensing system comprising:
an impeller device configured to receive a hot melt adhesive;
a pump having a first input configured to receive the hot melt adhesive and a second input configured to receive a gas, wherein the pump is configured to mix the hot melt adhesive and the gas to produce a solution and pump the solution at a volumetric flow rate;
a valve configured to control an amount of the gas provided to the pump through the second input; and
a dispenser configured to receive the solution from the pump and dispense the solution to create the hot melt adhesive foam.

2.-4. (canceled)

5. The dispensing system of claim 1, wherein the impeller device is configured and/or implemented as a semi open impeller driven by a common idler shaft.

6. The dispensing system of claim 1, wherein the impeller device is configured to be implemented as a pump inlet priming impeller.

7.-8. (canceled)

9. The dispensing system of claim 1, wherein the impeller device comprises an impeller.

10. The dispensing system of claim 9, wherein the impeller is arranged in an impeller housing.

11.-19. (canceled)

20. The dispensing system of claim 1, further comprising a heat exchanger arranged in a manifold and/or includes a manifold.

21. (canceled)

22. The dispensing system of claim 20, wherein the heat exchanger comprises lower heat fins.

23. The dispensing system of claim 20, wherein the heat exchanger comprises side heat fins.

24. The dispensing system of claim 20, wherein the heat exchanger comprises a heat exchanger inlet configured and arranged to receive hot melt adhesive from the pump or other component of the dispensing system.

25. The dispensing system of claim 20, wherein the heat exchanger comprises a heat exchanger outlet configured and arranged to output hot melt adhesive to a filter or other component of the dispensing system.

26. The dispensing system of claim 24, wherein the heat exchanger comprises at least one heat exchange tube.

27.-47. (canceled)

48. A dispensing system for dispensing hot melt adhesive foam onto a substrate, the dispensing system comprising:
a heat exchanger arranged in a manifold and/or includes a manifold;
a pump having a first input configured to receive a hot melt adhesive and a second input configured to receive a gas, wherein the pump is configured to mix the hot melt adhesive and the gas to produce a solution and pump the solution at a volumetric flow rate;
a valve configured to control an amount of the gas provided to the pump through the second input; and
a dispenser configured to receive the solution from the pump and dispense the solution to create the hot melt adhesive foam.

49. (canceled)

50. The dispensing system of claim 48, wherein the heat exchanger comprises lower heat fins.

51. The dispensing system of claim 48, wherein the heat exchanger comprises side heat fins.

52. The dispensing system of claim 48, wherein the heat exchanger comprises a heat exchanger inlet configured and arranged to receive hot melt adhesive from the pump or other component of the dispensing system.

53. The dispensing system of claim 48, wherein the heat exchanger comprises a heat exchanger outlet configured and arranged to output hot melt adhesive to a filter or other component of the dispensing system.

54.-62. (canceled)

63. The dispensing system of claim 48, further comprising an impeller device configured to receive a hot melt adhesive.

64.-66. (canceled)

67. The dispensing system of claim 63, wherein the impeller device is configured and/or implemented as a semi open impeller driven by a common idler shaft.

68. The dispensing system of claim 63, wherein the impeller device is configured to be implemented as a pump inlet priming impeller.

69.-84. (canceled)

85. A method of dispensing hot melt adhesive foam onto a substrate, the method comprising:
receiving a hot melt adhesive to an impeller device from a hot melt adhesive source;
receiving a gas from a gas source;
mixing the hot melt adhesive and the gas to produce a solution;
pumping the solution from a pump to a dispenser at a volumetric flow rate;
lowering a temperature of the hot melt adhesive with a heat exchanger arranged in a manifold and/or includes a manifold; and
dispensing the solution to create the hot melt adhesive foam.

86.-96. (canceled)
